(19) United States
(12) Patent Application Publication
(10) Pub. No.: US 2026/0142704 A1
(43) Pub. Date: May 21, 2026

(54) BEAM MEASUREMENT AND REPORT ACCURACY ENHANCEMENT

(71) Applicant: Google LLC, Mountain View, CA (US)

(72) Inventor: Yushu Zhang, Beijing (CN)

(21) Appl. No.: 19/119,373

(22) PCT Filed: Nov. 4, 2022
(86) PCT No.: PCT/CN2022/129908

§ 371 Date: Apr. 8, 2025

(51) Int. Cl. H04B 7/06; H04B 17/318; H04W 24/10

(52) U.S. Cl. CPC H04B 7/0626; H04B 7/06952; H04W 24/10; H04B 17/328

(57) ABSTRACT

Systems, devices, apparatuses, and methods, including computer programs encoded on storage media, define beam measurement and reporting enabling to predict best beams using an ML model. A UE (102) receives (308), from a network entity (104), a configuration for a measurement report using a beam quality quantization procedure. The measurement report corresponds to at least one of: a CSI report, an L1-RSRP report, or an L1-SINR report that are each based on a beam measurement that uses one or more CSI-RSs as a CMR. The UE (102) receives (312), from the network entity (104), the one or more CSI-RSs for the beam measurement and transmits (316), to the network entity (104), the measurement report. The measurement report is based on the beam measurement and the beam quality quantization procedure.

### TECHNICAL FIELD

The present disclosure relates generally to wireless communication, and more particularly, to enhancing beam measurement and reporting accuracy.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband have been useful to continue the progression of such wireless communication technologies. For example, machine learning (ML) models integrated into mobile broadband applications may be used to generate predictions for beams in a beam set without having to physically measure each beam in the beam set. For instance, a first measurement value determined for one or more measured beams of the beam set may be used to predict a second measurement value for one or more unmeasured beams in the beam set without measuring the unmeasured beams. However, a low accuracy input to the ML model might cause the ML model to generate a low accuracy output, which can degrade system performance.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A machine learning (ML) model can be implemented to predict top N beams that are likely to have best qualities among a beam set. The ML model may generate the prediction without a user equipment (UE) actually measuring the beam quality of every beam in the beam set. For example, beam measurements, such as layer 1 reference signal received power (L1-RSRP) and/or layer 1 signal-to-interference plus noise ratio (L1-SINR) measurements, for a subset of beams in the beam set can be input to the ML model to generate the prediction of the top N beams. A first ML model predicts top beams for the current UE position (e.g., valid if the UE is not moving) and a second ML model predicts top beams if the UE moves with a known/constant velocity.

If a network performs the ML model training and inference procedures, and the subset of beams in the beam set that the UE measures and reports to the network correspond to beams of reduced beam quality, the input to the ML model might have low accuracy. Tn other examples, the ML model might be located at the UE, such that the UE can report highest quality beams to the network. An inaccurate input to the ML model might cause the ML model to generate an inaccurate output (e.g., an inaccurate spatial-domain beam prediction), which can degrade the performance of the U E and a network entity, such as a base station or a radio unit of a base station.

The above-noted and other deficiencies are alleviated by improving a UE's beam measurement and reporting accuracy based on increasing a coverage of a beam measurement reference signal (e.g., channel state information-reference signal (CSI-RS)), reducing interference and noise at a UE receiver, and/or implementing a high-resolution quantization procedure to reduce a quantization error in beam reports. Improving the beam measurement and reporting accuracy can support improved spatial-domain beam predictions from the ML model. Better beam predictions improve a beam selection for communication between the UE and the network entity thereby increasing the overall system performance.

According to some aspects, the UE receives, from the network entity, a configuration for a measurement report using a beam quality quantization procedure. “Beam quality quantization procedure” refers to a procedure for determining report content for each bit associated with a measured beam quality. For example, if the UE reports the L1-RSRP via 7 bits and the UE measures the L1-RSRP at −120 dBm, the UE may determine how to quantize/report the 120 dBm L1-RSRP in the 7 bits. The measurement report corresponds to at least one of a channel state information (CSI) report, an L1-RSRP report, or an L1-SINR report that are each based on a beam measurement that uses one or more CSI-RSs as a channel measurement resource (CMR). The UE receives, from the network entity, the one or more CSI-RSs for the beam measurement and transmits, to the network entity, the measurement report. The measurement report is based on the beam measurement and the beam quality quantization procedure.

According to some aspects, the network entity, transmits, to the UE, a configuration for the measurement report, as described above. The network entity further transmits, to the UE, one or more CSI-RSs that serve as the CMR and receives, from the UE based on the beam quality quantization procedure of CSI-RS measurements, the measurement report based on the beam quality quantization procedure and the one or more CSI-RSs.

### BRIEF DESCRIPTION OF THE DRAWINGS

FIG. 1 illustrates a diagram of a wireless communications system that includes a plurality of UEs and network entities in communication over one or more cells.

FIG. 2 is a diagram illustrating an ML-based spatial-domain beam prediction procedure.

FIG. 3 illustrates a signaling diagram for beam reporting based on a channel state information (CSI) report configuration.

FIG. 4 illustrates a signaling diagram for layer 1 reference signal received power (L1-RSRP)/layer 1 and signal-to-interference plus noise ratio (L1-SINR) reporting.

FIG. 5 illustrates a signaling diagram for beam reporting in association with reported beams fulfilling a first threshold criterion.

FIGS. 6A-6B illustrate diagrams of differential and absolute aperiodic slot offset configurations.

FIGS. 7A-7B illustrate diagrams for channel state information-reference signal (CSI-RS) transmissions based on a configured number of repetitions.

FIG. 8 is a flowchart of a method of wireless communication at a UE.

FIG. 9 is a flowchart of a method of wireless communication at a network entity.

FIG. 10 is a diagram illustrating a hardware implementation for an example UE apparatus.

FIG. 11 is a diagram illustrating a hardware implementation for one or more example network entities.

### DETAILED DESCRIPTION

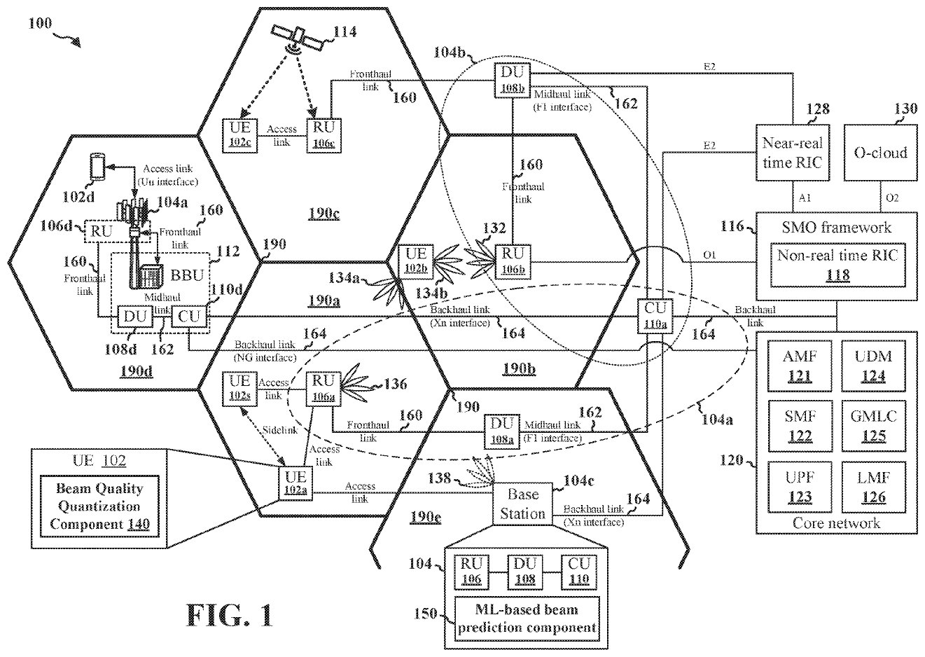

FIG. 1 illustrates a diagram of a wireless communications system 100 associated with a plurality 190 of cells 190a-e. The wireless communications system includes UEs 102a-d and base stations 104a-c, where some base stations (e.g., 104c) include an aggregated base station architecture and other base stations (e.g., 104a-104b) include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). A base station 104 and/or a unit of the base station 104, such as the RU 106, the DU 108, or the CU 110, may be referred to as a transmission reception point (TRP).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

One or more CUs 110, such as the CU 110a or the CU 100d, may communicate directly with a core network 120 via a backhaul link 164. For example, the CU 110_{d} communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an AI link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104c communicates with the CU 110a of the base station 104b over the backhaul link 164 based on the Xn interface. Similarly, the base station 104c of the cell 190e may communicate with the CU 110a of the base station 104b over a backhaul link 164 based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104c of the cell 190e via cross-cell communication beams of the RU 106a and the base station 104c.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DIU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or cross-cell communication beams. For example, the UE 102b of the cell 190b may communicate with the RU 106a of the cell 190a via a third set of communication beams 134a of the UE 102b and an RU beam set 136 of the RU 106a. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the AI interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the AI link. The near-real time RIC 128 may utilize the parameters and/or other information received from the non-real time RIC 118 or the SMO framework 116 via the AI link to perform near-real time functionalities. The near-real time RIC 128 and the non-real time RIC 118 may be configured to adjust a performance of the RAN. For example, the non-real time RIC 118 monitors patterns and long-term trends to increase the performance of the RAN. The non-real time RIC 118 may also deploy AI/ML models for implementing corrective actions through the SMO framework 116, such as initiating a reconfiguration of the O1 link or indicating management procedures for the AI link.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104c of cell 190d to transmit a downlink/forward link communication to the UE 102d or receive an uplink/reverse link communication from the UE 102d based on the Uu interface associated with the access link between the UE 102d and the base station 104c/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer earners may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 2425 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz. and FR5, which ranges from 11425 GHz-300 GHz. The upper limit of FR5 corresponds to the upper limit of the E1-IF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134b from the RU 106b in one or more receive directions of the UE 102b. In a further example, the UE 102b may also transmit an uplink beamformed signal to the RU 106b based on the second set of beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104c and a second base station 104b. For instance, the RU 106a of cell 190a may transmit a beamformed signal based on the RU beam set 136 to the base station 104c of cell 190e in one or more transmit directions of the RU 106a. The base station 104c of the cell 190e may receive the beamformed signal from the RU 106a based on a base station beam set 138 in one or more receive directions of the base station 104c. Similarly, the base station 104c of the cell 190e may transmit a beamformed signal to the RU 106a based on the base station beam set 138 in one or more transmit directions of the base station 104c. The RU 106a may receive the beamformed signal from the base station 104c of the cell 190e based on the RU beam set 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an LAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN). In some examples, the UE 102b operates in dual connectivity (DC) with the base station 104a and the base station 104b. In such cases, the base station 104a can be a master node and the base station 104b can be a secondary node. In other examples, the UE 102b operates in DC with the DU 108a and the DU 108b. In such cases, the DU 108a can be the master node and the DU 108b can be the secondary node.

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as Nell as other functional entities. For example, the one or more location servers include one or more location/positioning, servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSI UEs, a base station 104, and/or an entity at a base station 104, such as an RU 106.

Still referring to FIG. 1, in certain aspects, a UE 102 (which is any of the UEs 102a-e) may include a beam quality quantization component 140 configured to receive, from a network entity, a configuration for a measurement report using a beam quality quantization procedure, the measurement report comprising at least one of a channel state information (CSI) report, a layer 1 reference signal received power (L1-RSRP) report, or a layer 1 signal-to-interference plus noise ratio (L1-SINR) report that are each based on a beam measurement that uses one or more channel state information-reference signals (CSI-RSs) as a channel measurement resource (CMR); receive, from the network entity, the one or more CSI-RSs for the beam measurement; and transmit, to the network entity, the measurement report, the measurement report based on the beam measurement and the beam quality quantization procedure. “Beam quality quantization procedure” refers to a procedure for determining report content for each bit associated with a measured beam quality. For example, if the UE reports the L1-RSRP via 7 bits and the UE measures the L1-RSRP at −120 dBm, the UE may determine how to quantize/report the 120 dBm L1-RSRP in the 7 bits.

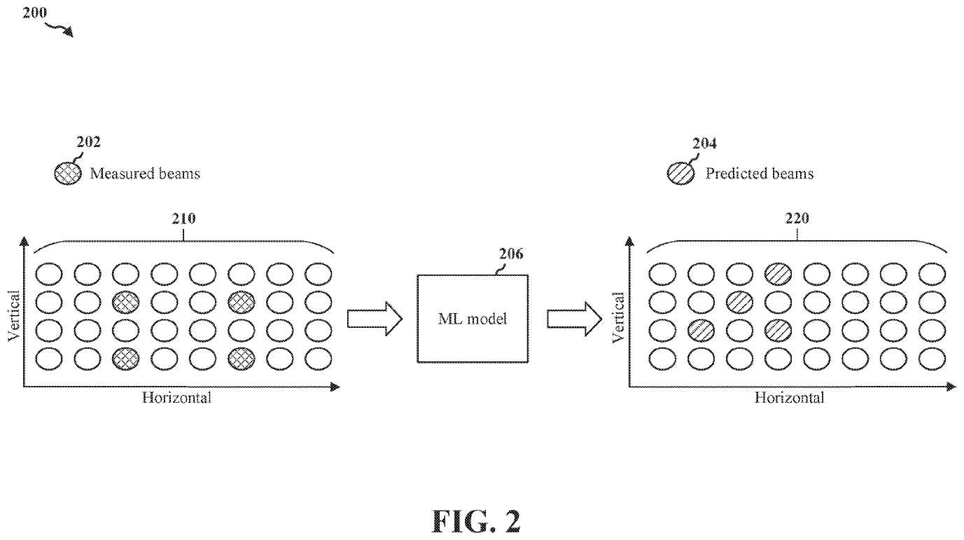

In certain aspects, a base station 104 (which is any of the base stations 104a-c or a network entity) may include a machine learning (ML)-based beam prediction component 150 configured to transmit, to a UE, a configuration for a measurement report that uses a beam quality quantization procedure, the measurement report comprising at least one of: a CSI report, an L1-RSRP report, or an L1-SINR report that are each based on one or more CSI-RSs that serve as a CMR; transmit, to the UE, the one or more CSI-RSs that serve as the CMR; and receive, from the UE, the measurement report, the measurement report based on the beam quality quantization procedure and the one or more CSI-RSs. Accordingly, FIG. 1 illustrated a wireless communication system whose components may operate as shown in one or more of FIGS. 2-7. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2 is an illustration 200 of an ML-based spatial-domain beam prediction procedure. A vertical direction in the illustration 200 indicates a vertical portion of an angle and a horizontal direction in the illustration 200 indicates a horizontal portion of the angle. A beam may be generated as a function based on f(vertical angle, horizontal_angle).

A cell radius/coverage area of a base station might be based on a link budget. The “link budget” refers to an accumulation of total gains and losses in a system, which provide a received signal level at a receiver, such as a UE. The receiver may compare the received signal level to a receiver sensitivity to determine whether a channel provides at least a minimum signal strength for signals communicated between the receiver and a transmitter (e.g., the UE and the base station).

In order to increase the link budget, the base station and the UE perform an analog beamforming operation to select a transmitter-receiver pair achieving an increased signal strength. Both the base station and the UE maintain a plurality of beams 210, 220 that may be used for the beam pair. A beam pair that decreases a coupling loss might result in an increased coverage gain for the base station and the UE. “Coupling loss” refers to a path loss/reduction in power density between a first transmit (Tx) antenna of the base station and a second receive (Rx) antenna of the UE, and may be indicated in units of decibel (dB). Beam selection procedures from the plurality of beams 210, 220 for activation of the beam pair by the base station and the UE might be associated with one or more of beam measurements (e.g., measured beams 202), beam reporting, or beam indication/prediction (e.g. predicted beams 204).

A first type of beam reporting might correspond to non-group based beam reporting, where the base station can configure the UE to measure and report an L1-RSRP) or an L1-SINR for a set of downlink reference signals from the base station. The downlink reference signals may correspond to synchronization signal blocks (SSBs), CSI-RSs, etc. The UE might report the L1-RSRP or the L1-SINR in each beam reporting instance for up to 4 SSBs or 4 CSI-RSs. A second type of beam reporting might correspond to group-based beam reporting, where the base station can configure the UE to measure and report the L1-RSRP or the L1-SINR for multiple groups of SSBs or CSI-RSs. Each beam group may include 2 SSBs or 2 CSI-RSs that that the UE can receive simultaneously.

Beam indication techniques based on Transmission Configuration Indicator (TCI) signaling may include joint beam indication or separate beam indications. “Joint beam indication” refers to a single/joint TC state that is used to update the beams 210, 220 for both the downlink channels/signals and the uplink channels/signals. For example, the base station can indicate a single/joint TCI state in downlink TCI signaling that is configured based on a DLorJointTClState parameter to update the beams 210, 220 for both the downlink channels/signals and the uplink channels/signals. For TCI signaling based on the joint TCI state, the base station may transmit an SSB or CSI-RS to indicate the Quasi-Co-Location(QCL) relationship between the downlink channels/signals and a spatial relation of the uplink channels/signals. In a first aspect, the transmitted TCI update signaling may correspond to a joint beam indication for both the downlink channels/signals and the uplink channels/signals.

“Separate beam indications” refers to a first TCI state that is used to update a first beam for the downlink channels/signals and a second TCT state that is used to update a second beam for the uplink channels/signals. For example, the base station can indicate the first TCI state in the downlink TCI signaling configured based on the DLorJointTCIState parameter to update the first beam for the downlink channels/signals, and may indicate the second TCI state in further downlink TCI signaling configured based on an UL-TCIState parameter to update the second beam for the uplink channels/signals. If the base station indicates the second TCI state (e.g., uplink TCI), the downlink reference signal may correspond to the SSB, the CSI-RS, etc. In examples where the second TCI state indicates an uplink reference signal (e.g. uplink TCI), the uplink reference signal may correspond to a sounding reference signal (SRS), which might indicate the spatial relation of the uplink channels/signals. In a second aspect, the transmitted TCI update signaling may correspond to either the downlink channels/signals or the uplink channels/signals based on the separate beam indications technique.

The base station may configure a QCL type and/or a source reference signal for the QCL signaling. QCL types for downlink reference signals might be based on a higher layer parameter, such as a qcl-Type in a QCL-Info parameter. A first QCL type that corresponds to typeA might be associated with a Doppler shift, a Doppler spread, an average delay, and/or a delay spread. A second QCL type that corresponds to typeB might be associated with the Doppler shift and/or the Doppler spread. A third QCL type that corresponds to typeC might be associated with the Doppler shift and/or the average delay. A fourth QCL type that corresponds to typeD might be associated with a spatial receive (Rx) parameter. The UE may use a same spatial transmission filter to indicate the spatial relation as used to receive the downlink reference signal from the base station or transmit the uplink reference signal. The transmitted TCI update signaling updates the TCI state for the channels of a component carrier (CC) that share the TCI state indicted in the TCI update signaling. The CC might be associated with a cell included in a cell list. The cell list is configured via RRC signaling, which may indicate parameters such as a simultaneousTCI-UpdateList1 parameter, a simultaneousTCI-UpdateList2 parameter, a simultaneousTCI-UpdateList3 parameter, or a simudtaneousTCI-UpdateList4 parameter.

Signaling communicated between the base station and the may be dedicated signaling or non-dedicated signaling. “Dedicated signaling” refers to signaling between the base station and the UE that is UE-specific. For example, dedicated signaling may correspond to a physical downlink control channel (PDCCH), a PDSCH, a physical uplink control channel (PUCCH), or a physical uplink shared channel (PUSCH) associated with the cell list that shares the indicated TCI state. PUSCH/PUCCH triggered at the UE by downlink control information (DCI), activated based on a medium access control-control element (MAC-CE), or configured based on an uplink grant in RRC signaling from the base station are dedicated signals.

“Non-dedicated signaling” refers to signaling between the base station and a non-specific UE. For example, non-dedicated signaling may correspond to physical broadcast channel (PBCH), PDCCH/PDSCH transmissions from the base station for non-specific UEs, aperiodic CSI-RS, or SRS for codebook, non-codebook, or antenna switching. PDCCH in a control resource set (CORESET) associated with Types 0/0A/0B/1/2 common search spaces, and PDSCH scheduled by such PDCCH are non-dedicated signals. However, other PDCCH and PDSCH signaling may be dedicated signals. The search space type might be defined based on standardized protocols.

An ML model 206 can be implemented at either the base station or the UE to predict top N beams (e.g., predicted beams 204) that are likely to have best beam qualities among a beam set 220. The ML model 206 determines the predicted beams 204 without the UE measuring the beam quality of every beam in the beam set 210. For example, the UE measures a first set of beams 202 in the beam set 210. Beam measurements, such as L1-RSRP and/or L1-SINR measurements, for the first subset of beams in the beam set 210 may be input to the ML model 206 to generate the prediction of the top N beams (e.g., predicted beams 204) in the beam set 220 that are most likely to have the highest beam quality in the beam set 220. An example of generating an ML-based spatial domain beam prediction includes inputting L1-RSRP measurement results of a first set of beams (e.g., 4 measured beams 202) into the ML model 206, to output a second set of predicted top beams 204 (e.g., 4 predicted beams 204 that are different from the 4 measured beams 202) that are likely to yield the highest beam quality among the beams in the beam set 220. A next beam measurement procedure may be based on the second set of predicted beams 204.

The UE might measure and report the beam quality (e.g., L1-RSRP) for the first set of measured beams 202 (e.g., the 4 measured beams 202) that are used as input to the ML model 206 when ML training and inferencing occurs at the base station. If the beam quality for the 4 measured beams 202 is low, the L1-RSRP input to the ML model 206 might have low accuracy. An inaccurate input to the ML model 206 might cause the ML model 206 to generate an inaccurate output (e.g., an inaccurate spatial-domain beam prediction), which can degrade the performance of the UE and the base station. That is, measurement errors associated with the L1-RSRP input to the ML model 206 might lead to quantization errors.

A beam prediction accuracy for the predicted top N beams (e.g., predicted beams 204) may be based on the L1-RSRP for a strongest beam among the top N predicted beams being larger than the L1-RSRP for an ideal beam minus a 1 dB margin. An example simulation for spatial domain beam prediction accuracy is as follows:

| Predicted | Ideal | L1-RSRP with up |
|---|---|---|
| beam | L1-RSRP | to 5 dB error |
| Top-1 | 47.98% | 30.28% |
| Top-2 | 65.49% | 46.92% |
| Top-4 | 82.09% | 65.58% |
| Top-8 | 93.62% | 84.82% |

The beam measurement and reporting accuracy may be improved based on increasing a coverage of a beam measurement reference signal (e.g. CSI-RS), reducing interference and noise at a UE receiver, and/or implementing a high-resolution quantization procedure (e.g., a high information to bit ratio) to reduce the quantization error in the beam report. Improving the beam measurement and reporting accuracy can support improved spatial-domain beam predictions (e.g., predicted beams 204) from the ML model 206. Better predictions of the predicted beams 204 might improve a beam pair selection between the UE and the network entity and provide increased system performance.

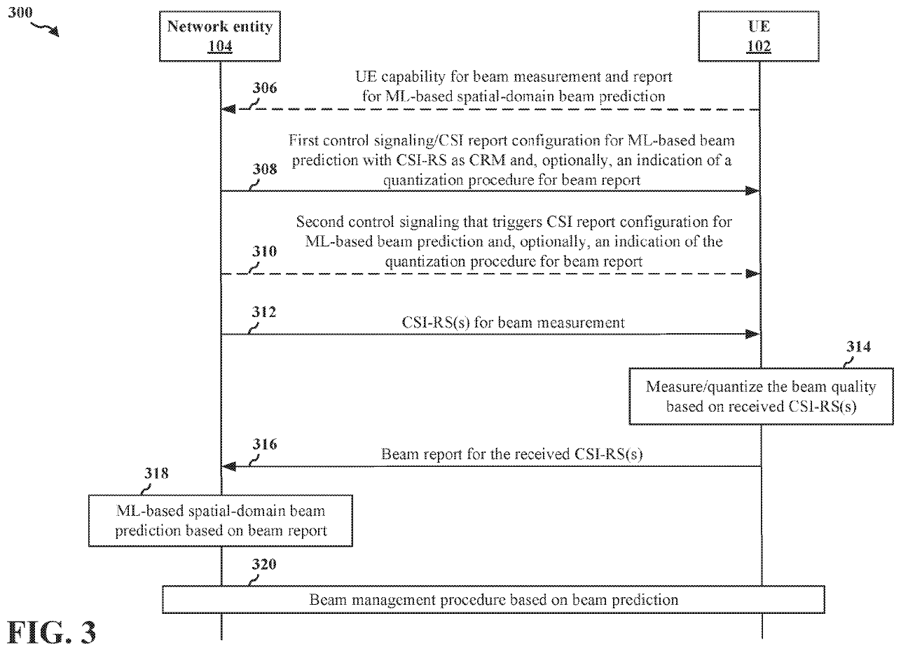

FIGS. 3-5 illustrate signaling diagrams for generating beam reports enabling to perform the ML-based spatial-domain beam prediction procedure. FIG. 3 illustrates a signaling diagram 300 for beam reporting based on a CSI report configuration. The UE 102 transmits 306 a UE capability report to the network entity 104 indicating one or more UE capabilities for beam measurement and reporting for enabling the network entity to perform an ML-based spatial-domain beam prediction at 318. The one or more UE capabilities may correspond to a maximum number of CSI-RS resources or symbols for a CSI-RS resource or CSI-RS resource sets configured for the measurements at 314 used to prepare the beam report, a maximum number of CSI-RS resources or symbols for the CSI-RS resource or CSI-RS resource sets in a slot for the measurements at 314 used to prepare the beam report, and/or a maximum number of reported beams in the beam report. In some embodiments, the network entity 104 can receive an indication of the one or more UE capabilities from a core network entity, such as the AMF 121 described in the diagram 100. The one or more UE capabilities may be counted per CC, per band, per band combination, or per UE. The one or more UE capabilities may be reported to the network entity 104 per feature set, per band, per band combination, or per UE.

A UE 102 with an enhanced receiver may transmit 306, to the network entity 104, one or more additional IE capabilities indicating that the UE 102 supports enhanced beam measurement and reporting techniques. For example, the UTE 102 may transmit 306 a UE capability report to the network entity 104 indicating a minimum processing delay for the TIE 102 to measure 314 a beam quality for a CSI report configuration with the enhanced receiver (e.g., L1-RSRP/L1-SINR measurements). The IE 102 may also indicate, in the UE capability report, UE's maximum number of beam measurement reference signals (e.g., SSB/CSI-RS) usable for the beam measurement 314 with the enhanced receiver and/or UE's maximum number of beam measurement reference signals (e.g., SSB/CSI-RS) in a slot for the beam measurement 314 with the enhanced receiver. The one or more additional UE capabilities associated with the enhanced receiver may be counted per CC, per band, per band combination, or per UE. The one or more additional UE capabilities associated with the enhanced receiver may be reported to the network entity 104 per feature set, per band, per band combination, or per UE. In some implementations, the UE 102 may report 306 two sets of the UE capabilities for the beam measurement and report, where the first set of IE capabilities is for the beam measurement and report based on a receiver with more measurement error and the second set of UE capabilities is for the beam measurement and report based on an advanced with less measurement error.

The network entity 104 transmits 308 first control signaling to the IE 102 to configure a CSI report configuration for an ML-based beam prediction 318 at the network entity 104. The control signaling may be based on the one or more U E capabilities that the network entity 104 receives 306 from the UE 102. In some embodiments, the network entity 104 may configure a list of CSI-RSs as CMRs for the beam report transmitted 316 to the network entity 104 for the ML-based spatial-domain beam prediction 318 at the network entity 104. The network entity 104 may optionally include an indication of a quantization procedure for the beam report in the first control signaling transmitted 308 to the UE 102.

The network entity 104 may transmit 308 the first control signaling using RRC signaling (e.g., CSI-ReportConfig). The RRC signaling may indicate, to the IE 102, an RRC reconfiguration message from the network entity 104 or a system information block (SIB). The SIB may be a predefined SIB (e.g., SIB1) or a different SIB (e.g., SIB J, where J is greater than 21). An RRC parameter included in the first control signaling may indicate to the UE 102 to quantize 314 the measured beam quality using a high-resolution quantization procedure. The RRC signaling may indicate that a CMR corresponds to a set of CSI-RS resources from a same port (e.g., CSI-RS resources in a resource set with RRC parameter repetition configured). The CMR may be the CSI-RS resource for one or more symbols to increase a coverage for the CSI-RS, where the number of symbols is configured by the network entity 104 via the RRC signaling. The CST-RS for each symbol may be from the same port.

The RRC signaling may also include parameters such as a report quantity indicative of whether to report L1-RSRP, L1-RSRP and L1-SINR, or L1-RSRP and a beam quality indicator (BQI). The RRC signaling further includes parameters such as a first threshold to determine whether the measured L1-SINR for a beam satisfies a threshold, a quantization procedure indicator (e.g., whether to enable high-resolution quantization), a quantization mode (e.g., whether the beam report is based on an absolute value or absolute value for one or more strongest beams and a differential value for remaining reported beams, and/or a high measurement accuracy flag used to indicate whether the network entity 104 requests high measurement accuracy for the beam measurement and report. The high measurement accuracy may cause the UE 102 to activate the enhanced receiver of the UE 102 (e.g., a receiver with interference and noise suppression capabilities). The network entity 104 can configure the UE 102 to report L1-RSRP and L1-SINR based on reportQuantity=cri-RSRP-SINR or RSRP-SINR. The network entity 104 can configure the UE to report L1-RSRP and BQI based on reportQuantity=cri-RSRP-BQI or RSRP-BQI. The network entity 104 can configure the first threshold based on sinrThreshold. The network entity 104 can enable the high-resolution quantization based on highResQuantization. The network entity 104 can configure the quantization mode based on quantizationMode. The network entity 104 can configure the high measurement accuracy flag based on highAccuracy.

The UE 102 may receive 310 second control signaling from the network entity 104 that triggers the CSI report configuration for the beam report for the ML-based spatial-domain beam prediction 318 at the network entity 104. The second control signaling may correspond to a MAC-CE or DCI. For semi-persistent CSI reporting, the second control signaling may correspond to the MAC-CE. For aperiodic CSI reporting, the second control signaling may correspond to the DCI. The network entity 104 may optionally include an indication of a quantization procedure for the beam report in the second control signaling transmitted 310 to the UE 102.

The second control signaling may include parameters similar to the parameters described with respect to the first control signaling. In examples, some of the parameters may be predefined parameters. For example, the first threshold for the measured L1-SINR for a beam may be predefined or configured as −10 dB. The parameters may also indicate that a quantization procedure indicator is enabled when the beam report is based on L1-RSRP+L1-SINR or L1-RSRP+BQI report. The parameters may further indicate that a quantization mode is based on an absolute mode when the beam report is based on L1-RSRP+L1-SINR or L1-RSRP+BQI report. The parameters may further indicate that a high measurement accuracy flag is enabled when the beam report is based on L1-RSRP+L1-SINR or L1-RSRP+BQI report. The network entity 104 may refrain from configuring time-domain measurement restrictions, such as timeRestrictionForChannefMeasurmients and/or tinieRestrictionForInterferenceMeasurements, so that the UE 102 does not activate layer-1 filters for receiving periodic/semi-persistent CMRs at different time instances, which might decrease an accuracy of the measurement 314.

The network entity 104 transmits 312 the CST-RS(s) for the beam measurement to the UE 102. In examples, the network entity 104 can transmit 314 the one or more CSI-RSs using a repetition-based procedure to increase the coverage of the CSI-RSs. The network entity 104 can transmit 312 N CSI-RS resources in a resource set from one or more same ports based on the network entity 104 configuring the RRC parameter repetitions for the CSI-RS resource set. The network entity 104 may transmit 312 the N CSI-RS resources in N symbols within one or more slots. The network entity 104 may refrain from transmitting 312 the N CST-RS resources in different bandwidths or different resource elements.

The UE 102 receives 312 the CSI-RSs configured as the CMRs and measures 314 the beam quality. The UE 102 also determines a quantization procedure for the beam quality measurement 314 of the CST-RSs and quantizes 314 the beam quality based on the quantization procedure. The UE 102 can measure the L1-RSRP/L1-SINR based on the N CSI-RS resources. The UE 102 may receive 312 the CSI-RS resources based on joint channel estimation.

For multi-slot transmission (e.g., A slots transmission), the network entity 104 may configure the slot index m for each CSI-RS resource within the M slots using the first control signaling and/or the second control signaling. For aperiodic CSI-RS resource sets, the network entity 104 configures a slot offset for the first slot using an RRC parameter aperiodic TriggeringOfset and configures the slot offset for each CSI-RS resource based on aperiodicTriggeringOffset+m. The network entity 104 configures the slot offset for each CSI-RS resource, such that the UE 102 may disregard the slot offset configured for the CSI-RS resource set when the slot offset for each CSI-RS is configured by the network entity 104. The network entity 104 may configure a differential slot offset for the CSI-RS resource within a resource set based on the RRC parameter aperiodicTriggeiringOIsetWithinSet, where the slot offset for the CSI-RS resource corresponds to aperiodicTriggeringOfjwet+aperiodicTriggeringOffsetWithinSet.

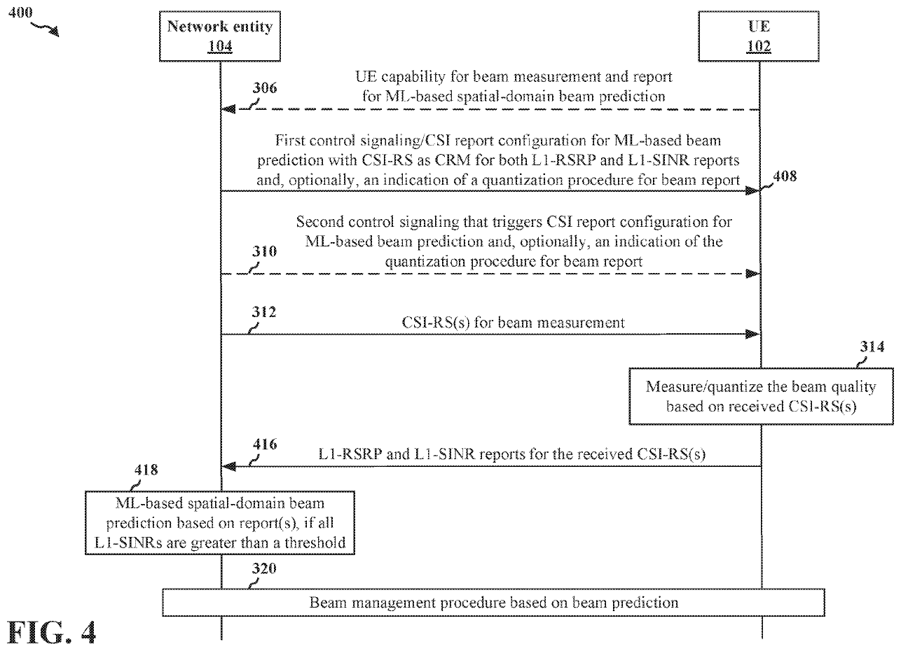

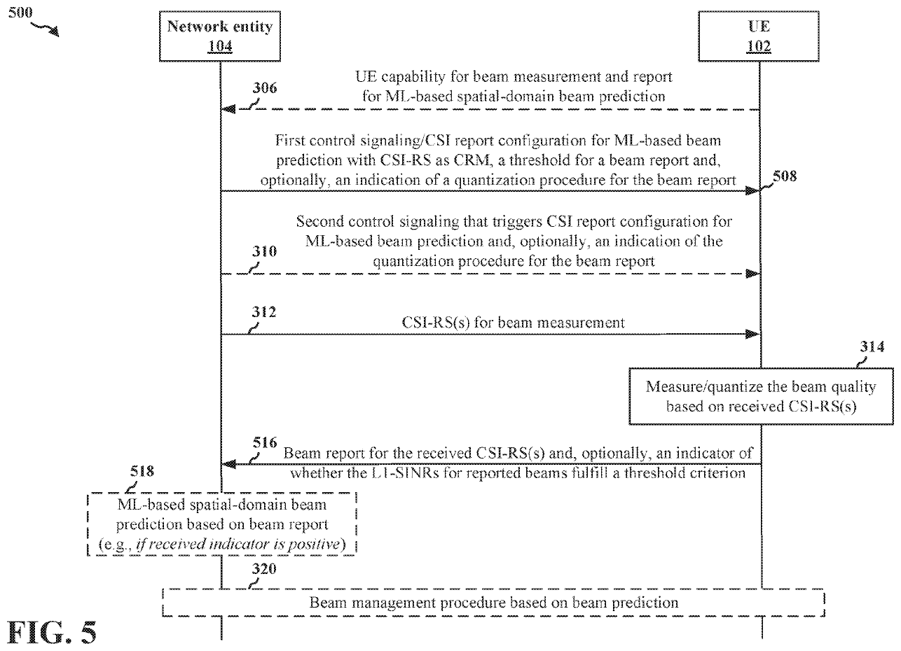

The UE 102 transmits 316 the beam report for the received CSI-RS(s) to the network entity 104. The beam report is based on the measured/quantized 314 beam quality for the received CSI-RSs. The UE 102 may transmit 316 the beam report to the network entity 104 via PUCCH or PUSCH resources. The network entity 104 performs 318 the ML-based spatial-domain beam prediction based on the beam report (e.g., the measured/quantized 314 beam quality for the CSI-RS(s)). The network entity 104 can perform 320 a beam management procedure with the UE 102 based on the beam prediction 318. FIG. 3 describes beam reporting based on a CSI report configuration. FIGS. 4-5 describe specific types of CSI report configurations.

FIG. 4 illustrates a signaling diagram 400 for L1-RSRP/L1-SINR reporting. Elements 306, 310, 312, 314, and 320 have already be described with respect to FIG. 3. The network entity 104 transmits 408 first control signaling to the UE 102 to configure a CSI report configuration for an ML-based beam prediction 418 at the network entity 104. The network entity 104 configures one or more CSI-RSs as CMRs for both an L1-RSRP report and an L1-SINR report transmitted 416 to the network entity 104 for the ML-based spatial-domain beam prediction 418 at the network entity 104. The network entity 104 may optionally include an indication of a quantization procedure for the beam report in the first control signaling transmitted 408 to the UE 102.

The UE 102 transmits 416, to the network entity 104, the L1-RSRP/L1-SINR report(s) for the received CST-RS(s). The L1-RSRP/L1-SINR report(s) are based on the measured/quantized 314 beam quality for the received CSI-RSs. The network entity 104 can determine, based on the reported L1-SINR, whether to perform 418 ML-based spatial-domain beam prediction. For example, the network entity 104 performs 418 the ML-based spatial-domain beam prediction for the L1-RSRP/L1-SINR report(s), if all L1-SINRs in the report are greater than a threshold. In other examples, the network entity 104 may determine not to perform 418 the ML-based spatial-domain beam prediction when the L1-SINR for at least some of the reported beams are below the threshold. If the network entity 104 performs 418 the beam prediction based on all the L1-SINRs being greater than the threshold, the network entity 104 can further perform 320 a beam management procedure with the UE 102 based on the beam prediction 318.

FIG. 5 illustrates a signaling diagram 500 for beam reporting in association with reported beams fulfilling a first threshold criterion. Elements 306, 310, 312, 314, and 320 have already be described with respect to FIG. 3.

The network entity 104 transmits 508 first control signaling to the UE 102 to configure a CSI report configuration for an ML-based beam prediction 418 at the network entity 104. The network entity 104 configures one or more CSI-RSs as CMRs as well as a threshold for a beam report (e.g., −10 dB) transmitted 516 to the network entity 104. The network entity 104 may optionally include an indication of a quantization procedure for the beam report in the first control signaling transmitted 508 to the UE 102.

In an implementation, the network entity 104 configures the UE 102 to transmit 516 the beam report for the received CSI-RS(s) and an indicator of whether the L1-SINRs for the reported beams fulfill a first threshold criterion (e.g., the threshold configured via the first control signaling). The threshold may be a predefined threshold (e.g., L1-SINR greater than −10 dB). The UE 102 can indicate, in the beam report, the L1-RSRP for the configured beams and include an indicator of whether the L1-SINR for all the reported beams is greater than the threshold. The network entity 104 may perform 518 the ML-based spatial-domain beam prediction based on the received L1-RSRP for the configured beams, if the received indicator of all the L1-SINRs being greater than the threshold is positive. Alternatively, the network entity 104 may switch to a non-ML-based beam management procedure, if the received indicator is negative.

In another implementation, the UE 102 does not transmit 516 the beam report for the received CSI-RS(s), if the L1-SINR for all the reported beams is less than or equal to the threshold. That is, the UE 102 does not report the L1-RSRP for the configured beams. Hence, the network entity 104 may perform 518 the ML-based spatial-domain beam prediction based on the beam report being received 516 from the UE 102. The network entity 104 may further perform 320 the beam management procedure with the UE 102 based on the network entity 104 performing 518 the ML-based spatial-domain beam prediction.

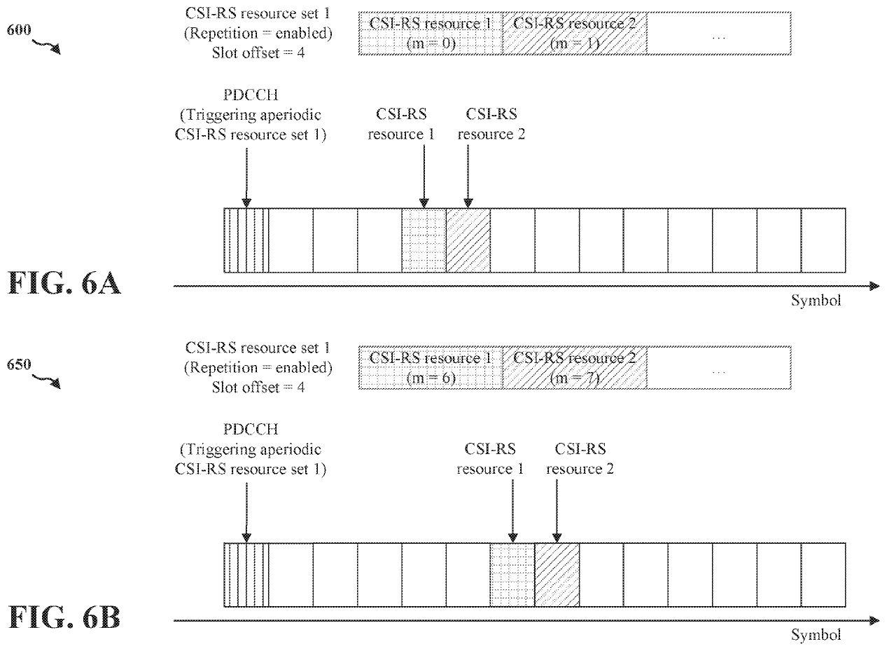

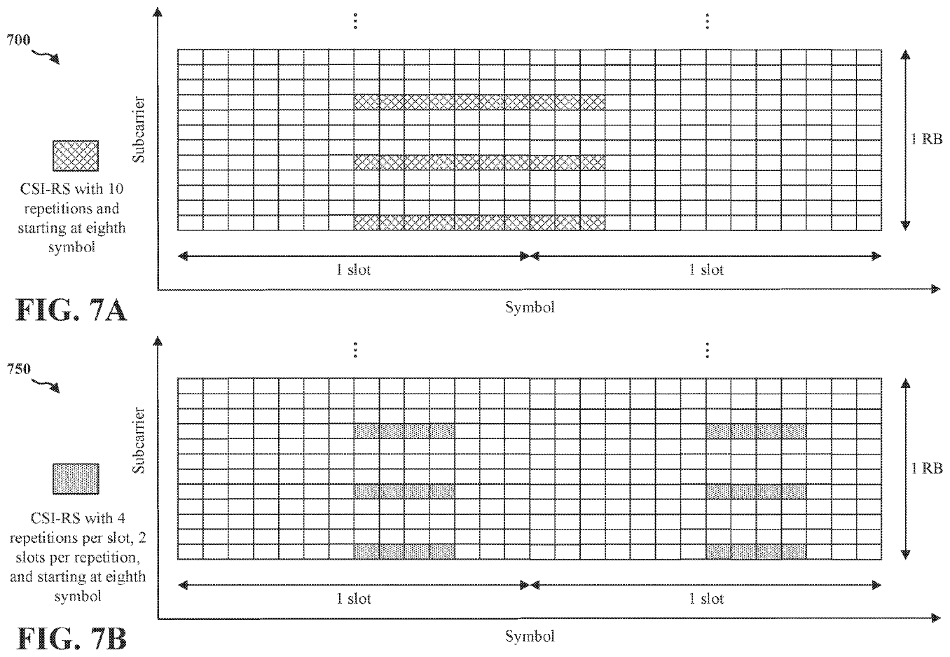

Accordingly, if the L1-SINR for the received CSI-RS(s) is greater than the configured threshold, the UE 102 may report the L1-RSRP for the received CSI-RS(s) and either transmit 516 an indicator of whether the L1-SINR for the received CST-RS(s) is greater than the threshold or transmits 516 the beam report based on the L1-SINR for the received CSI-RS(s) being greater than the threshold. If the L1-SINR for the received CSI-RS(s) is less than or equal to the configured threshold, the UE 102 may indicate the L1-RSRP for the received CSI-RS(s) and either transmits 516 an indication that the L1-SINR for at least one of the received CSI-RS(s) is less than or equal to the threshold or not transmits 516 the beam report based on the L1-SINR for the received CSI-RS(s) being less than or equal to the threshold. FIGS. 3-5 describe reporting procedures for enabling beam predictions. FIGS. 6A-6B and 7A-7B describe CSI-RS resource configurations for enabling the reporting procedures.

FIG. 6A illustrates a diagram 600 of a differential aperiodic slot offset configuration. FIG. 6B illustrates a diagram 650 of an absolute aperiodic slot offset configuration.

The network entity may configure a CSI-RS resource set 1 with repetitions enabled and a slot offset equal to 4. The network entity transmits a PDCCH to trigger the CSI-RS resource set 1 when the CSI-RS resource set 1 is aperiodic. In the diagram 600 for the differential aperiodic slot offset configuration, the CSI resource set 1 corresponds to m=0 and a CSI resource set 2 corresponds to in =2. Hence, the CSI-RS resource 1 in the diagram 600 is configured at 0 slots after the 4-slot offset from the PDCCH triggering slot, and the CSI-RS resource 2 is at configured at 1 slot after the 4-slot offset from the PDCCH triggering slot.

In the diagram 650 for the absolute aperiodic slot offset configuration, the CSI resource set 1 corresponds to m=6 and the CSI resource set 2 corresponds to m=7. Hence, the CSI-RS resource 1 in the diagram 650 is configured at 6 absolute slots after the PDCCH triggering slot, and the CSI-RS resource 2 is at configured at 7 absolute slots after the PDCCH triggering slot. The network entity may configure the absolute slot offset for the CSI-RS resources based on an RRC parameter aperiodicTriggeringOffsetPerResource.

The network entity transmits a CSI-RS resource for an L1-RSRP/L1-SINR measurement in N symbols or N repetitions. The network entity may transmit the N-symbol CSI-RS in one slot or more than one slot. The network entity may configure the number of symbols and/or the number of slots for a CSI-RS resource via RRC signaling. The UE measures the L1-RSRP/L1-SINR based on the N symbols/repetitions for the CST-RS resource. The UE may receive the N symbols/repetitions for the CSI-RS resource based on joint channel estimation. In an example, the network entity configures the number of repetitions/symbols for the CSI-RS resources based on the RRC parameter nrofRepetitions configured in CSI-RS-ResourceMapping or in a CSI-RS resource (e.g., NZP-CSI-RS-Resource). The network entity transmits the CSI-RSs in repetition in consecutive symbols according to the nrofRepetitions parameters.

FIGS. 7A-7B illustrate diagrams 700-750 for CSI-RS transmissions based on a configured number of repetitions. The diagram 700 illustrates the CSI-RS being configured with 10 repetitions (e.g., over 3 subcarriers per resource block (RB)) starting at an eighth symbol. The 10 repetitions in the diagram 700 occur over portions of 2 different slots.

The network entity can also configure the number of repetitions within a slot separately from and a number of slots based on the RRC parameters nrotRepetitionsWithinSlot and nrofSlots in CSI-RS-ResourceMapping or in a CSI-RS resource (e.g., NZP-CSI-RS-Resource). The network entity may transmit the CSI-RS resource in consecutive symbols based on the nrofRepetitions parameter for repetitions within the slot and transmit the CSI-RS resource in the number of slots based on the nrofSlots parameter. The diagram 750 illustrates CSI-RS transmission with the number of repetitions parameter configured. The CSI-RS in the diagram 750 is configured with 4 repetitions per slot, 2 slots per repetition, and a starting time at an eighth symbol of each slot.

The UE can apply a high-resolution L1-RSRP quantization procedure to the reported L1-RSRP based on the indication in the first/second control signaling. The network entity may configure a range for the reported L1-RSRP and/or a step size for the L1-RSRP quantization with the high-resolution quantization procedure. The range of the reported L1-RSRP for the high-resolution quantization procedure may be predefined (e.g., −160 dBm to −20 dBm). The step size for the L1-RSRP for the high-resolution quantization procedure may also be predefined (e.g., 0.5 dB). The range of differential L1-RSRP may be configured by the network entity through RRC signaling or may be predefined (e.g., −40 dB to 0 dB). The step size for the differential L1-RSRP may also be configured by the network entity through RRC signaling or may be predefined (e.g., 0.5 dB).

The UE may report both the L1-RSRP and the L1-SINR for the configured CMRs or a subset of the configured CMRs and the UE may transmit the beam report in CSI part 1 or CSI part 2. The UE can report an absolute L1-RSRP/L1-SINR for the configured CMRs. A reporting format for an absolute report of N configured CMRs may correspond to reporting the L1-RSRP for CMR 1 through CMR N followed by the L1-SINR for CMR 1 through CMR N.

The UE can report an absolute L1-RSRP/L1-SINR for the CMR with a strongest L1-RSRP/L1-SINR, and report a differential L1-RSRP/L1-SINR with the absolute L1-RSRP and L1-SINR as a reference for remaining configured CMRs. The reporting format for a differential report for N configured CMRs may correspond to a reporting order of CMR index k1 with a strongest L1-RSRP, L1-RSRP for CMR 1, . . . , differential L1-RSRP for CMR k1−1, differentia L1-RSRP for CMR k1+1, . . . , differential L1-RSRP for CMR N, CMR index k2 with a strongest L1-SINR, L1-SINR for CMR 1, . . . , differential L1-SINR for CMR k2-1, differential L1-SINK for CMR k2+1, . . . , differential L1-SINR for CMR N.

The UE can report CMR indexes for M selected CMRs, where M<N, and an absolute L1-RSRP/L1-SINR for the M CMRs. A reporting format for an absolute report for the M selected CMRs may correspond to reporting the CMR index x₁ through the CMR index x_{M}, followed the L1-RSRP for CMR x₁ through CMR x_{M}, followed by the L1-SINR for CMR x₁ through CMR x_{M}.

The UE may report an absolute L1-RSRP/L1-SINR for the CMR with the strongest L1-RSRP/L1-SINR, and report differential L1-RSRP/L1-SINR with the absolute L1-RSRP/L1-SINR as a reference for the remaining M-1 selected CMRs. A reporting format for the differential report for the M selected CMRs may correspond to a reporting order of XMR index x1 through CMR index x_{M}, followed by L1-RSRP for the CMR x₁, followed by a differential L1-RSRP for CMR x₂ through a differential L1-RSRP for CMR x₁, followed by L1-SINR for the CMK x₁, followed by a differential L1-SINR for CMR x₂ through a differential L1-RSRP for CMR x_{M}.

The UE may report the 1-RSRP and a BQI for the configured CMRs or a subset of the configured CMRs. The UE reports the absolute/differential L1-RSRP for beams with a positive BQI. The UE may also report the number of CMRs with a positive BQI. The UE may likewise report the number of CMRs, the CMR index, and the L1-RSRP in a same CSI part or different CSI parts. The UE can indicate a bitmap for the CMRs with positive BQI and absolute/different L1-RSRP for the CMRs with the positive BQI. A CMR may correspond to a CSI-RS resource or a CSI-RS resource set. The UE may report a CMR index based on reporting a CSI-RS resource indicator or a CSI-RS resource set indicator. The UE may report a positive BQI for a C MIR when the L1-SINR for the CMR is greater than a threshold. Otherwise, the UE reports a negative BQI

The UE reports the number of CMRs in CSI part 1 and reports the CMR index and the absolute/differential L1-RSRP for the beams with the positive BQI in CSI part 2. The UE may indicate a bitmap for the CMRs with the positive BQI in the CSI part 1 and report the absolute/different L1-RSRP for the CMRs with the positive BQI in the CSI part 2. A payload size of the L1-RSRP in the CSI part 2 is based on a number of reported positive BQIs in the CSI part 1. A report format for absolute or differential L1-RSRP for Q CMRs with a positive BQI may correspond to reporting CMR index x₁ through CMR index x_{Q}, followed by the L1-RSRP for the CMR index x₁, followed by the absolute or differential L1-RSRP for the CMR x₂ through the CMR x_{Q}.

The UE can report the absolute or differential L1-RSRP for the configured or selected CMRs, and report the BQI to indicate whether the L1-SINR for any of the reported CMR is less than or equal to the threshold configured by the first control signaling. The UE may report the CMRs, absolute L1-RSRP for the configured N CMRs, and the BQI based on a reporting format that corresponds to reporting the BQI followed by the L1-RSRP for the CMR 1 through the L1-RSRP for the CMR N. In another example, the UE may report the CMR index and the absolute L1-RSRP for the selected M CMRs and the BQI based on a reporting format that corresponds to reporting CMR index x₁ through CMR index x_{M}, followed by the L1-RSRP for CMR index x₁ through the L1-RSRP for CMR index x_{M}, followed by the BQI.

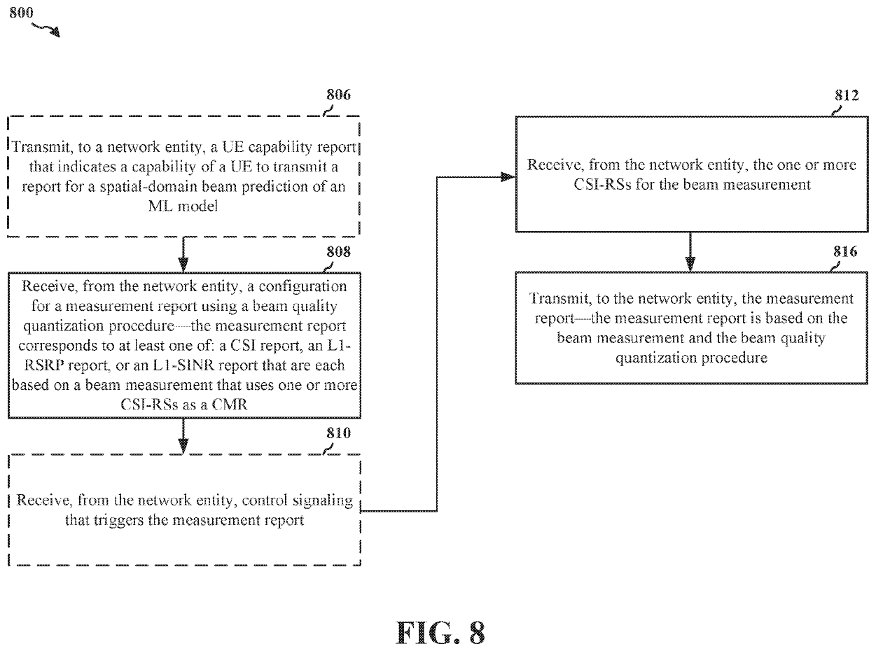

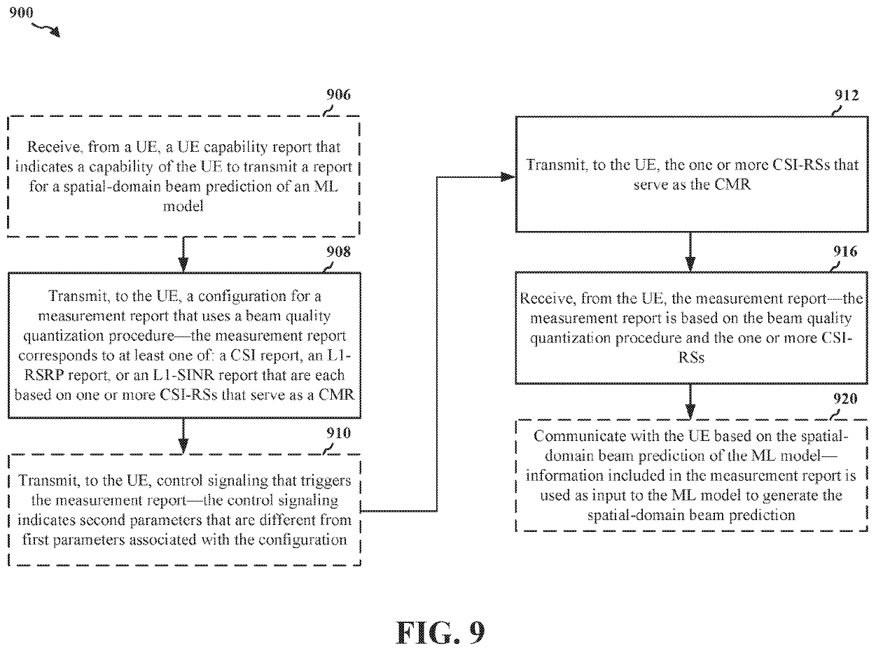

The UE may implicitly report the BQI in some examples, such as where the U E transmits the beam report with a different scrambling identifier (ID) for different BQI state. The network entity may configure different scrambling IDs associated with different BQI via RRC signaling. Alternatively, the UE may transmit the beam report with different resources for different BQI The network entity configures the different resources (e.g., PUCCH resources) for the beam report associated with the different BQI via the RRC signaling. The UE can also report the L1-RSRP for the configured CMRs or a subset of the configured CMRs when the L1-SINR for the reported CMRs is greater than the threshold. Otherwise, the UE may not report the L1-RSRP. FIGS. 2-7B illustrate techniques for enabling ML-based beam predictions. FIGS. 8-9 show methods for implementing one or more aspects of FIGS. 2-7B. In particular, FIG. 8 shows an implementation by the UE 102 of the one or more aspects of FIGS. 2-7B. FIG. 9 shows an implementation by the network entity 104 of the one or more aspects of FIGS. 2-7B.

FIG. 8 illustrates a flowchart 800 of a method of wireless communication at a UE. With reference to FIGS. 1, 3-5, and 10, the method may be performed by the UE 102, the UE apparatus 1002, etc., which may include the memory 1026′, 1006′, 1016, and which may correspond to the entire UE 102 or the entire UE apparatus 1002, or a component of the U E 102 or the UE apparatus 1002, such as the wireless baseband processor 1026 and/or the application processor 1006.

The UE 102 transmits 806, to a network entity, a UE capability report that indicates a capability of a UE to transmit a report for a spatial-domain beam prediction of an ML model. For example, referring to FIGS. 3-5, the UE 102 transmits 306, to the network entity 104, a UE capability report for a beam measurement and report for an ML-based spatial-domain beam prediction at the network entity 104.

The UE 102 receives 808, from the network entity, a configuration for a measurement report using a beam quality quantization procedure—the measurement report corresponds to at least one of: a CSI report, an L1-RSRP report, or an L1-SINR report that are each based on a beam measurement that uses one or more CST-RSs as a CMR. For example, referring to FIGS. 3 and 5, the UE 102 receives 308, 508, from the network entity 104, first control signaling that indicates a CSI report configuration for transmission of a beam report for an ML-based beam prediction. Referring to FIG. 4, the UE 102 receives 408, from the network entity 104, first control signaling that indicates a CSI report configuration for transmission of an L1-RSRP/L1-SINR report for an ML-based beam prediction.

The UE 102 receives 810, from the network entity, control signaling that triggers the measurement report. For example, referring to FIGS. 3-5, the UE 102 receives 310, from the network entity 104, second control signaling that triggers the CSI report configuration for the measurement report for the ML-based beam prediction.

The UE 102 receives 812, from the network entity, the one or more CSI-RSs for the beam measurement. For example, referring to FIGS. 3-5, the UE 102 receives 312, from the network entity 104, CSI-RS(s) for beam measurement.

The UE 102 transmits 816, to the network entity, the measurement report—the measurement report is based on the beam measurement and the beam quality quantization procedure. For example, referring to FIGS. 3 and 5, the UE 102 transmits 316, 516, to the network entity 104, a beam measurement for the received CSI-RS(s). Referring to FIG. 4, the UE 102 transmits 416, to the network entity 104, L1-RSRP/L1-SINR reports for the received CSI-RS(s). FIG. 8 describes a method from a UE-side of a wireless communication link, whereas FIG. 9 describes a method from a network-side of the wireless communication link.

FIG. 9 is a flowchart 900 of a method of wireless communication at a network entity. With reference to FIGS. 1, 3-5, and 11, the method may be performed by one or more network entities 104, which may correspond to a base station or a unit of the base station, such as the RU 106, the DU 108, the CU 110, an RU processor 1106, a DU processor 1126, a CU processor 1146, etc. The one or more network entities 104 may include memory 1106/1126′/1146′, which may correspond to an entirety of the one or more network entities 104, or a component of the one or more network entities 104, such as the RU processor 1106, the DU processor 1126, or the CU processor 1146.

The network entity 104 receives 906, from a UE, a UE capability report that indicates a capability of the UE to transmit a report for a spatial-domain beam prediction of an ML model. For example, referring to FIGS. 3-5, the network entity 104 receives 306, from the UE 102, a UE capability report for a beam measurement and report for an ML-based spatial-domain beam prediction at the network entity 104.

The network entity 104 transmits 908, to the UE, a configuration for a measurement report that uses a beam quality quantization procedure—the measurement report corresponds to at least one of a CSI report, an L1-RSRP report, or an L1-SINR report that are each based on one or more CSI-RSs that serve as a CMR. For example, referring to FIGS. 3 and 5, the network entity 104 transmits 308, 508, to the UE 102, first control signaling that indicates a CSI report configuration for transmission of a beam report for an ML-based beam prediction. Referring to FIG. 4, the network entity 104 transmits 408, to the UE 102, first control signaling that indicates a CSI report configuration for transmission of an L1-RSRP/L1-SINR report for an ML-based beam prediction.

The network entity 104 transmits 910, to the UE, control signaling that triggers the measurement report—the control signaling indicates second parameters that are different from first parameters associated with the configuration. For example, referring to FIGS. 3-5, the network entity 104 transmits 310, to the UE 102, second control signaling that triggers the CSI report configuration for the measurement report for the ML-based beam prediction.

The network entity 104 transmits 912, to the UE, the one or more CST-RSs that serve as the CMR. For example, referring to FIGS. 3-5, the network entity 104 transmits 312, to the UE 102, CSI-RS(s) for beam measurement.

The network entity 104 receives 916, from the UE, the measurement report—the measurement report is based on the beam quality quantization procedure and the one or more CSI-RSs. For example, referring to FIGS. 3 and 5, the network entity 104 receives 316, 516, from the UE 102, a beam measurement for the received CSI-RS(s). Referring to FIG. 4, the network entity 104 receives 416, from the UE 102, L1-RSRP/L1-SINR reports for the received CSI-RS(s).

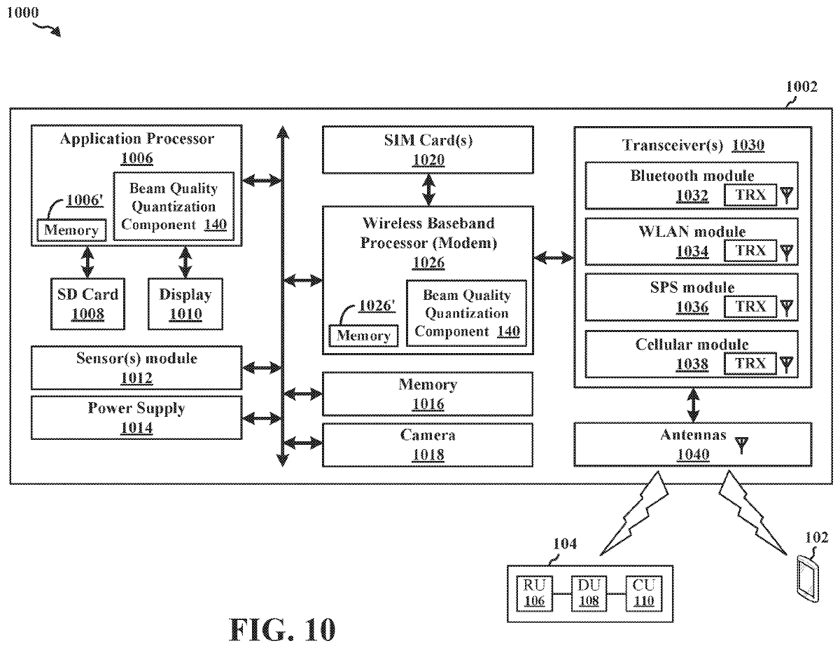

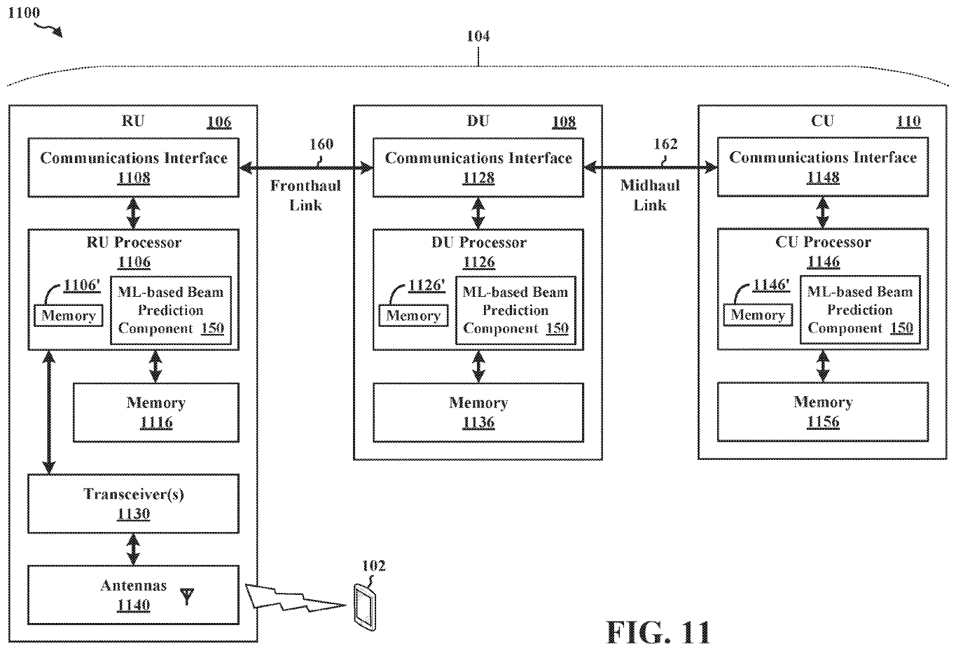

The network entity 104 communicates 920 with the UE based on the spatial-domain beam prediction of the ML model-information included in the measurement report is used as input to the ML model to generate the spatial-domain beam prediction. For example, referring to FIGS. 3-5, the network entity 104 communicates 320, with the UE 102, via a beam management procedure that is based on the beam prediction 318, 418, 518. A UE apparatus 1002, as described in FIG. 10, may perform the method of flowchart 800. The one or more network entities 104, as described in FIG. 11, may perform the method of flowchart 900.

FIG. 10 is a diagram 1000 illustrating an example of a hardware implementation for a UE apparatus 1002. The UE apparatus 1002 may be the UE 102, a component of the UE 102, or may implement UE functionality. The UE apparatus 1002 may include an application processor 1006, which may have on-chip memory 1006′. In examples, the application processor 1006 may be coupled to a secure digital (SD) card 1008 and/or a display 1010. The application processor 1006 may also be coupled to a sensor(s) module 1012, a power supply 1014, an additional module of memory 1016, a camera 1018, and/or other related components. For example, the sensor(s) module 1012 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1002 may further include a wireless baseband processor 1026, which may be referred to as a modem. The wireless baseband processor 1026 may have on-chip memory 1026′. Along with, and similar to, the application processor 1006, the wireless baseband processor 1026 may also be coupled to the sensor(s) module 1012, the power supply 1014, the additional module of memory 1016, the camera 1018, and/or other related components. The wireless baseband processor 1026 may be additionally coupled to one or more subscriber identity module (SIM) card(s) 1020 and/or one or more transceivers 1030 (e.g., wireless RF transceivers).

Within the one or more transceivers 1030, the UE apparatus 1002 may include a Bluetooth module 1032, a WLAN module 1034, an SPS module 1036 (e.g., GNSS module), and/or a cellular module 1038. The Bluetooth module 1032, the WLAN module 1034, the SPS module 1036, and the cellular module 1038 may each include an on-chip transceiver (TRX), or in some cases, just a transmitter (TX) or just a receiver (RX). The Bluetooth module 1032, the WLAN module 1034, the SPS module 1036, and the cellular module 1038 may each include dedicated antennas and/or utilize antennas 1040 for communication with one or more other nodes. For example, the UE apparatus 1002 can communicate through the transceiver(s) 1030 via the antennas 1040 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1026 and the application processor 1006 may each include a computer-readable medium/memory 1026, 1006′, respectively. The additional module of memory 1016 may also be considered a computer-readable medium/memory. Each computer-readable medium/memory 1026′. 1006′, 1016 may be non-transitory. The wireless baseband processor 1026 and the application processor 1006 may each be responsible for general processing, including execution of software stored on the computer-readable medium/memory 1026′, 1006′, 1016. The software, when executed by the wireless baseband processor 1026/application processor 1006, causes the wireless baseband processor 1026/application processor 1006 to perform the various functions described herein. The computer-readable medium/memory may also be used for storing data that is manipulated by the wireless baseband processor 1026/application processor 1006 when executing the software. The wireless baseband processor 1026/application processor 1006 may be a component of the UE 102. The UE apparatus 1002 may be a processor chip (e.g., modem and/or application) and include just the wireless baseband processor 1026 and/or the application processor 1006. In other examples, the UE apparatus 1002 may be the entire UE 102 and include the additional modules of the apparatus 1002.

As discussed, the beam quality quantization component 140 is configured to receive, from a network entity, a configuration for a measurement report using a beam quality quantization procedure, the measurement report comprising at least one of a CSI report, an L1-RSRP report, or an L1-SINR report that are each based on a beam measurement that uses one or more CSI-RSs as a CMR; receive, from the network entity, the one or more CSI-RSs for the beam measurement; and transmit, to the network entity, the measurement report, the measurement report based on the beam measurement and the beam quality quantization procedure. The beam quality quantization component 14) may be within the wireless baseband processor 1026, the application processor 1006, or both the wireless baseband processor 1026 and the application processor 1006. The beam quality quantization component 140 may be one or more hardware components specifically configured to carry out the stated processes/algorithm, implemented by one or more processors configured to perform the stated processes/algorithm, stored within a computer-readable medium for implementation by the one or more processors, or a combination thereof.

The U E apparatus 1002 may include a variety of components configured for various functions. In examples, the UE apparatus 1002, and in particular the wireless baseband processor 1026 and/or the application processor 1006, includes means for receiving, from a network entity, a configuration for a measurement report using a beam quality quantization procedure, the measurement report comprising at least one of: a CSI report, an L1-RSRP report, or an L1-SINR report that are each based on a beam measurement that uses one or more CSI-RSs as a CMR; means for receiving, from the network entity, the one or more CSI-RSs for the beam measurement; and means for transmitting, to the network entity the measurement report, the measurement report based on the beam measurement and the beam quality quantization procedure. The UE apparatus 1002 further includes means for receiving from the network entity, control signaling that triggers the measurement report. The U apparatus 1002 further includes means for transmitting, to the network entity, a UE capability report that indicates at least one of: a first capability of the UE to transmit a report for a spatial-domain beam prediction of an ML model, a first maximum number of CSI-RS resources, symbols for a CSI-RS resource, or CSI-RS resource sets configured for the report, a second maximum number of the CST-RS resources, the symbols for the CSI-RS resource, or the CSI-RS resource sets in a slot for the report, a third maximum number of reported beams in the report, a second capability of a UE receiver for the report, or a minimum processing delay to perform the beam measurement for the report based on the UE receiver.

The means for receiving the one or more CSI-RSs for the beam measurement is further configured to at least one of: receive, from the network entity, a repetition of the one or more CSI-RSs, or receive, from the network entity, the one or more CSI-RSs on CSI resources of one or more same antenna ports. The means for transmitting the measurement report is further configured to: transmit a first measurement value of the L1-RSRP and a second measurement value of the BQI for the one or more CSI-RSs. The means for transmitting the measurement report is further configured to: transmit a CMR index and at least one of a first measurement value of the L1-RSRP, a second measurement value of the BQI, or a third measurement value of the LA-SINR for the CMR. The means may be the beam quality quantization component 140 of the UE apparatus 1002 configured to perform the functions recited by the means.

FIG. 11 is a diagram 1100 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1146, which may have on-chip memory 1146′. In some aspects, the CU 110 may further include an additional module of memory 1156 and/or a communications interface 1148, both of which may be coupled to the CU processor 1146. The CU 110 can communicate with the DU 108 through a midhaul link 162, such as an F1 interface between the communications interface 1148 of the CU 110 and a communications interface 1128 of the DU 108.

The D 108 may include a DU processor 1126, which may have on-chip memory 1126. In some aspects, the DU 108 may further include an additional module of memory 1136 and/or the communications interface 1128, both of which may be coupled to the DU processor 1126. The DU 108 can communicate with the RU 106 through a fronthaul link 160 between the communications interface 1128 of the DU 108 and a communications interface 1108 of the RU 106.

The RU 106 may include an RU processor 1106, which may have on-chip memory 1106′. In some aspects, the RU 106 may further include an additional module of memory 1116, the communications interface 1108, and one or more transceivers 1130, all of which may be coupled to the RU processor 1106. The RU 106 may further include antennas 1140, which may be coupled to the one or more transceivers 1130, such that the RU 106 can communicate through the one or more transceivers 1130 via the antennas 1140 with the UE 102.

The on-chip memory 1106′, 1126′. 1146′ and the additional modules of memory 1116, 1136, 1156 may each be considered a computer-readable medium/memory. Each computer-readable medium/memory may be non-transitory. Each of the processors 1106, 1126, 1146 is responsible for general processing, including execution of software stored on the computer-readable medium/memory. The software, when executed by the corresponding processor(s) 1106, 1126, 1146 causes the processor(s) 1106, 1126, 1146 to perform the various functions described herein. The computer-readable medium/memory may also be used for storing data that is manipulated by the processor(s) 1106, 1126, 1146 when executing the software. In examples, the ML-based beam prediction component 150 may sit at the one or more network entities 104, such as at the CL 110; both the CU 110 and the DU 108; each of the CU 110, the DU 108, and the RU 106; the DU 108; both the DU 108 and the RU 106; or the RU 106.

As discussed, the ML-based beam prediction component 150 is configured to transmit, to a LIE, a configuration for a measurement report that uses a beam quality quantization procedure, the measurement report comprising at least one of: a CSI report, an L1-RSRP report, or an L1-SINR report that are each based on one or more CSI-RSs that serve as a CMR; transmit, to the LIE, the one or more CSI-RSs that serve as the CMR; and receive, from the UE, the measurement report, the measurement report based on the beam quality quantization procedure and the one or more CSI-RSs. The ML-based beam prediction component 150 may be within one or more processors of the one or more network entities 104, such as the RU processor 1106, the DU processor 1126, and/or the CU processor 1146. The ML-based beam prediction component 150 may be one or more hardware components specifically configured to carry out the stated processes/algorithm, implemented by one or more processors 1106, 1126, 1146 configured to perform the stated processes/algorithm, stored within a computer-readable medium for implementation by the one or more processors 1106, 1126, 1146, or a combination thereof.

The one or more network entities 104 may include a variety of components configured for various functions. In examples, the one or more network entities 104 include means for transmitting, to a UE, a configuration for a measurement report that uses a beam quality quantization procedure, the measurement report comprising at least one of: a CSI report, an L1-RSRP report, or an L1-SINR report that are each based on one or more CSI-RSs that serve as a CMR; means for transmitting, to the UE, the one or more CSI-RSs that serve as the CMR; and means for receiving, from the UE, the measurement report, the measurement report based on the beam quality quantization procedure and the one or more CSI-RSs. The one or more network entities 104 further include means for transmitting, to the UE, control signaling that triggers the measurement report, the control signaling indicating second parameters that are different from first parameters associated with the configuration. The one or more network entities 104 further include means for receiving, from the UE, a UE capability report that indicates at least one of: a first capability of the UE to transmit a report for a spatial-domain beam prediction of an ML model, a first maximum number of CSI-RS resources, symbols for a CSI-RS resource, or CSI-RS resource sets configured for the report, a second maximum number of the CSI-RS resources, the symbols for the CST-RS resource, or the CSI-RS resource sets in a slot for the report, a third maximum number of reported beams in the report, a second capability of a JE receiver for the report, or a minimum processing delay to perform a beam measurement for the report based on the UE receiver. The one or more network entities 104 further include means for communicating with the UE based on the spatial-domain beam prediction of the ML model, where information included in the measurement report is used as input to the ML model to generate the spatial-domain beam prediction.

The means for transmitting the one or more CSI-RSs is further configured to at least one of transmit, to the UE, a repetition of the one or more CSI-RSs, or transmit, to the UE, the one or more CSI-RSs on CST resources associated with one or more same antenna ports of the UE. The means may be the ML-based beam prediction component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The descriptions set forth herein describe various configurations in connection with the drawings and but do not represent the only configurations in which the concepts described in this section may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in this section and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the formations may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-nodule-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B. or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a configuration for a measurement report using a beam quality quantization procedure, the measurement report including at least one of: a CSI report, an L1-RSRP report, or an L1-SINR report that are each based on a beam measurement that uses one or more CST-RSs as a CMR; receiving, from the network entity, the one or more CSI-RSs for the beam measurement; and transmitting, to the network entity, the measurement report, the measurement report being based on the beam measurement and the beam quality quantization procedure.

Example 2 may be combined with example 1 and further includes receiving, from the network entity, control signaling that triggers the measurement report.

Example 3 may be combined with example 2 and includes that the control signaling indicates second parameters for the beam quality quantization procedure that are different from first parameters associated with the configuration.

Example 4 may be combined with any of examples 1-3 and further includes transmitting, to the network entity, a UE capability report that indicates at least one of, a first capability of the UE to transmit a report for a spatial-domain beam prediction of an ML model, a first maximum number of CSI-RS resources, symbols for a CST-RS resource, or CSI-RS resource sets, a second maximum number of the CSI-RS resources, the symbols for the CSI-RS resource, or the CSI-RS resource sets in a slot for the report, a third maximum number of predicted beams in the report, a second capability of a UE receiver for the report, or a minimum processing delay between the beam measurement for the UE receiver and the report based on the beam measurement for the UE receiver.

Example 5 may be combined with any of examples 1-4 and includes that the configuration indicates at least one of: a report quantity parameter for reporting at least one of an L1-RSRP, an L1-SINR, or a BQI, a first threshold for a quality of the beam measurement, a first indicator of the beam quality quantization procedure, a second indicator of a quantization mode for the report, the quantization mode corresponding to a first absolute value for a set of beams or a second absolute value for a subset of beams in the set of beams and a differential value for remaining beams in the set of beams, a measurement accuracy indicator associated with a UE receiver, a differential slot offset for CSI-RS resources, an absolute slot offset for the CSI-RS resources, a first number of total repetitions of the one or more CSI-RSs, or a second number of repetitions of the one or more CSI-RSs in a slot or number of slots.

Example 6 may be combined with any of examples 1-5 and includes that the receiving of the one or more CSI-RSs for the beam measurement includes at least one of: receiving, from the network entity, a repetition of the one or more CSI-RSs, or receiving, from the network entity, the one or more CSI-RSs on CSI resources of one or more same antenna ports.

Example 7 may be combined with any of examples 1-6 and includes that the transmitting of the measurement report includes: transmitting a first measurement value of the L1-RSRP and a second measurement value of a BQI for the one or more CSI-RSs.

Example 8 may be combined with any of examples 1-6 and includes that the transmitting of the measurement report includes: transmitting a CMR index and at least one of a first measurement value of the L1-RSRP, a second measurement value of a BQI, or a third measurement value of the L1-SINR for the CMR.

Example 9 may be combined with example 8 and includes that the CMR index corresponds to a CSI-RS resource indicator or a CSI-RS resource set indicator.

Example 10 may be combined with example 8 and includes that a value of the BQI is positive when the L1-SINR for all beams in a set of reported beams is less than a second threshold, and where the value of the BQI is negative when the L i-SINR for at least a subset of beams in the set of reported beams is greater than the second threshold.

Example 11 may be combined with example 8 and includes that at least one of the CMR index, the first measurement value of the L1-RSRP, or the second measurement value of the BQI is transmitted in at least one of CSI part 1 or CST part 2.

Example 12 may be combined with any of examples 1-11 and includes that the configuration includes a parameter that increases a resolution of the beam quality quantization procedure.

Example 13 is a method of wireless communication at a network entity, including: transmitting, to a UE, a configuration for a measurement report that uses a beam quality quantization procedure, the configuration directing the UE to include, in the measurement report, at least one of: a CST report, an LT-RSRP report or an L1-SINR report that are each based on one or more CSI-RSs that serve as a CMR; transmitting, to the UE, the one or more CSI-RSs; and receiving, from the UE, the measurement report, the measurement report being based on the beam quality quantization procedure and the one or more CSI-RSs.

Example 14 may be combined with example 13 and further includes transmitting, to the UE, control signaling that triggers the measurement report, the control signaling indicating second parameters for the beam quality quantization procedure that are different from first parameters associated with the configuration.

Example 15 may be combined with any of examples 13-14 and further includes: receiving, from the UE, a UE capability report that indicates at least one of: a first capability of the UE to transmit a report for a spatial-domain beam prediction of an ML model, a first maximum number of CSI-RS resources, symbols for a CSI-RS resource, or CSI-RS resource sets, a second maximum number of the CSI-RS resources, the symbols for the CSI-RS resource, or the CSI-RS resource sets in a slot for the report, a third maximum number of reported beams in the report, a second capability of a UE receiver for the report, or a minimum processing delay to perform a beam measurement for the report based on the UE receiver.

Example 16 may be combined with any of examples 13-15 and includes that the transmitting the one or more CSI-RSs includes at least one of: transmitting, to the UE, a repetition of the one or more CSI-RSs, or transmitting, to the UE, the one or more CSI-RSs on CSI resources associated with one or more same antenna ports of the UE.

Example 17 may be combined with any of examples 13-16 and further includes communicating with the UE based on the spatial-domain beam prediction of the ML model, where information included in the measurement report is used as input to the ML model to generate the spatial-domain beam prediction.

Example 18 may be combined with example 17 and includes that the information is input to the ML model to generate the spatial-domain beam prediction when at least one of a value of a BQI is positive or the L1-SINR for all beams in a set of reported beams is greater than a threshold.

Example 19 is an apparatus for wireless communication for implementing a method as in any of examples 1-18.

Example 20 is an apparatus for wireless communication including means for implementing a method as in any of examples 1-18.

Example 21 is a non-transitory computer-readable medium storing computer executable code, the code when executed by a processor causes the processor to implement a method as in any of examples 1-18.

1. A method of wireless communication at a user equipment (UE), comprising:
receiving, from a network entity, a configuration for a measurement report using a beam quality quantization procedure, the measurement report comprising at least one of:
a channel state information (CSI) report,
a layer 1 reference signal received power (L1-RSRP) report, or
a layer 1 signal-to-interference plus noise ratio (L1-SINR) report that are each based on a beam measurement that uses one or more channel state information-reference signals (CSI-RSs);
receiving, from the network entity, the one or more CSI-RSs for the beam measurement; and
transmitting, to the network entity, the measurement report, the measurement report being-based on the beam measurement and the beam quality quantization procedure.

2. The method of claim 1, further comprising:
receiving, from the network entity, control signaling that triggers the measurement report, wherein the receiving the one or more CSI-RSs comprises receiving an aperiodic CSI-RS based on a first slot offset and a second slot offset, wherein the first slot offset is from a triggering slot of the aperiodic CSI-RS, wherein the second slot offset is an additional offset from the first slot offset.

3. The method of claim 2, wherein the control signaling indicates second parameters for the beam quality quantization procedure that are different from first parameters associated with the configuration.

4. The method of claim 1, further comprising:
transmitting, to the network entity, a UE capability report that indicates at least one of:
a first capability of the UE to transmit a report for a spatial-domain beam prediction of a machine learning (ML) model,
a first maximum number of CSI-RS resources, symbols for a CSI-RS resource, or CSI-RS resource sets,
a second maximum number of the CSI-RS resources, the symbols for the CSI-RS resource, or the CSI-RS resource sets in a slot for the report,
a third maximum number of predicted beams in the report,
a second capability of a UE receiver for the report, or
a minimum processing delay between the beam measurement for the UE receiver and the report based on the beam measurement for the UE receiver.

5. The method of claim 1, wherein the configuration indicates at least one of:
a report quantity parameter for reporting at least one of an L1-RSRP, an L1-SINR, or a beam quality indicator (BQI),
a first threshold for a quality of the beam measurement,
a first indicator of the beam quality quantization procedure,
a second indicator of a quantization mode for the measurement report,
a measurement accuracy indicator associated with a UE receiver,
a differential slot offset for CSI-RS resources,
an absolute slot offset for the CSI-RS resources,
a first number of total repetitions of the one or more CSI-RSs, or
a second number of repetitions of the one or more CSI-RSs in a slot or number of slots.

6. The method of claim 1, wherein the receiving of the one or more CSI-RSs for the beam measurement comprises at least one of:
receiving, from the network entity, a repetition of the one or more CSI-RSs, or
receiving, from the network entity, the one or more CSI-RSs on CSI resources of more than one antenna port.

7. The method of claim 1, wherein the transmitting of the measurement report comprises:
transmitting a first measurement value of an L1-RSRP and a second measurement value of a beam quality indicator (BQI) for the one or more CSI-RSs.

8. The method of claim 1, wherein the transmitting of the measurement report comprises:
transmitting a channel measurement resource (CMR) index and at least one of a first measurement value of an L1-RSRP, a second measurement value of a beam quality indicator BQI), or a third measurement value of an L1-SINR for a CMR.

9. The method of claim 8, wherein the CMR index corresponds to a CSI-RS resource indicator or a CSI-RS resource set indicator.

10. The method of claim 8, wherein a value of the BQI is positive when the L1-SINR for all beams in a set of reported beams is less than a second threshold, and wherein the value of the BQI is negative when the L1-SINR for at least a subset of beams in the set of reported beams is greater than the second threshold.

11. The method of claim 8, wherein at least one of the CMR index, the first measurement value of the L1-RSRP, or the second measurement value of the BQI is transmitted in at least one of CSI part 1 or CSI part 2.

12. The method of claim 1, wherein the configuration includes a parameter that increases a resolution of the beam quality quantization procedure.

13. A method of wireless communication at a network entity, comprising:
transmitting, to a user equipment (UE), a configuration for a measurement report that uses a beam quality quantization procedure, the configuration directing the UE to include, in the measurement report, at least one of:
a channel state information (CSI) report,
a layer 1 reference signal received power (L1-RSRP) report, or
a layer 1 signal-to-interference plus noise ratio (L1-SINR) report that are each based on one or more channel state information-reference signals (CSI-RSs);
transmitting, to the UE, the one or more CSI-RSs; and
receiving, from the UE, the measurement report, the measurement report based on the beam quality quantization procedure and the one or more CSI-RSs.

14. The method of claim 13, further comprising:
transmitting, to the UE, control signaling that triggers the measurement report, the control signaling indicating second parameters for the beam quality quantization procedure that are different from first parameters associated with the configuration.

15. The method of claim 13, further comprising:
receiving, from the UE, a UE capability report that indicates at least one of:
a first capability of the UE to transmit a report for a spatial-domain beam prediction of a machine learning (ML) model,
a first maximum number of CSI-RS resources, symbols for a CSI-RS resource, or CSI-RS resource sets,
a second maximum number of the CSI-RS resources, the symbols for the CSI-RS resource, or the CSI-RS resource sets in a slot for the report,
a third maximum number of reported beams in the report,
a second capability of a UE receiver for the report, or
a minimum processing delay to perform a beam measurement for the report based on the UE receiver.

16. The method of claim 13, wherein the transmitting of the one or more CSI-RSs comprises at least one of:
transmitting, to the UE, a repetition of the one or more CSI-RSs,
transmitting, to the UE, the one or more CSI-RSs on CSI resources associated with more than one antenna port of the UE,
transmitting, to the UE, an aperiodic CSI-RS based on a first slot offset and a second slot offset, wherein the first slot offset is from a triggering slot of the aperiodic CSI-RS, wherein the second slot offset is an additional offset from the first slot offset.

17. The method of claim 13, further comprising:
communicating with the UE based on a spatial-domain beam prediction of a machine learning (ML) model, wherein information included in the measurement report is used as input to the ML model to generate the spatial-domain beam prediction.

18. The method of claim 17, wherein the information is input to the ML model to generate the spatial-domain beam prediction when at least one of a value of a beam quality indicator (BQI) is positive or an L1-SINR for all beams in a set of reported beams is greater than a threshold.

19. An apparatus for wireless communication comprising:
a transceiver;
a memory; and
a processor coupled to the memory and the transceiver, the apparatus-being processor being configured to:
receive, from a network entity, a configuration for a measurement report using a beam quality quantization procedure, the measurement report comprising at least one of:
a channel state information (CSI) report,
a layer 1 reference signal received power (L1-RSRP) report, or
a layer 1 signal-to-interference plus noise ratio (L1-SINR) report that are each based on a beam measurement that uses one or more channel state information-reference signals (CSI-RSs);
receive, from the network entity, the one or more CSI-RSs for the beam measurement; and
transmit, to the network entity, the measurement report, the measurement report based on the beam measurement and the beam quality quantization procedure.

20. The apparatus of claim 19, wherein to receive the one or more CSI-RSs, the processor is configured to receive an aperiodic CSI-RS based on a first slot offset and a second slot offset, wherein the first slot offset is from a triggering slot of the aperiodic CSI-RS, wherein the second slot offset is an additional offset from the first slot offset.
